(19) United States
(12) Patent Application Publication
(10) Pub. No.: US 2008/0297446 A1
(43) Pub. Date: Dec. 4, 2008

(54) Plasma display panel

(76) Inventor: Takahisa Mizuta, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/153,418

(22) Filed: May 19, 2008

(30) Foreign Application Priority Data
May 31, 2007 (KR) 10-2007-0053411

(51) Int. Cl. G09G 3/28

(52) U.S. Cl. 345/60

(57) ABSTRACT

A plasma display panel includes a first substrate having first and second surfaces opposite each other, the first substrate including a plurality of grooves in the second surface, the grooves extending along a first direction, a plurality of address electrodes in the grooves along the first direction, a thickness of the address electrodes being smaller than a depth of the grooves to define a space between each address electrode and the second surface of the first substrate, a plurality of sustain electrodes on the second surface of the first substrate along a second direction, the second direction crossing the first direction, a second substrate facing the second surface of the first substrate, barrier ribs between the first and second substrates to define discharge cells between the first and second substrates, and at least one phosphor layer in each of the discharge cells.

### BACKGROUND OF THE INVENTION

1. Field of the Invention

Embodiments of the present invention relate to a plasma display panel (PDP). More particularly, embodiments of the present invention relate to a PDP that can be driven at a low voltage and has improved light emitting efficiency, discharge stability, and discharge efficiency.

2. Description of the Related Art

A conventional PDP refers to a flat display panel displaying images by exciting phosphors via UV light generated by gas discharge. The PDP may have a thin and large screen, and may exhibit high image resolution.

The conventional PDP may include first and second substrates spaced apart from each other with barrier ribs therebetween to define discharge cells, i.e., spaces to perform the gas discharge. The conventional PDP may further include sustain electrodes on the first substrate and address electrodes on the second substrate, so the barrier ribs may be between the sustain and address electrodes. Application of voltage to a discharge gas in the discharge cells via the electrodes may generate the discharge.

Positioning the sustain electrodes and the address electrodes on two different substrates, i.e., spaced apart from each other by the barrier ribs, may increase distance between the sustain electrodes and the address electrodes, so a required driving voltage of the PDP may increase. An increased driving voltage may reduce discharge efficiency of the PDP and decrease life time of the electrodes.

### SUMMARY OF THE INVENTION

Embodiments of the present invention are therefore directed to a PDP, which substantially overcomes one or more of the disadvantages of the related art.

It is therefore a feature of embodiments of the present invention to provide a PDP that may be driven at a low voltage and exhibits improved light emitting efficiency.

It is another feature of embodiments of the present invention to provide a PDP that may be driven at a low voltage and exhibits improved discharge stability.

It is yet another feature of embodiments of the present invention to provide a PDP that may be driven at a low voltage and exhibits high discharge efficiency.

At least one of the above and other features and advantages of the present invention may be realized by providing a PDP, including a first substrate with first and second surfaces opposite each other, the first substrate having a plurality of grooves in the second surface, the grooves extending along a first direction, a plurality of address electrodes in the grooves along the first direction, a thickness of the address electrodes being smaller than a depth of the grooves to define a space between each address electrode and the second surface of the first substrate, a plurality of sustain electrodes on the second surface of the first substrate along a second direction, the second direction crossing the first direction, a second substrate facing the second surface of the first substrate, barrier ribs between the first and second substrates to define discharge cells between the first and second substrates, and at least one phosphor layer in each of the discharge cells.

The PDP may further include an insulating layer between the address electrodes and the sustain electrodes. The insulating layer may be inside the grooves on the address electrodes. The insulating layer may be on the address electrodes and on the second surface of the first substrate. A surface of the insulating layer facing away from the address electrodes may be substantially flat. The insulating layer may be only inside the grooves. The insulating layer may include a plurality of discrete portions, each portion being in a respective groove. The insulating layer may completely fill the spaces between the address electrode and the second surface of the first substrate. A surface of the insulating layer facing away from the address electrodes may be substantially level with the second surface of the first substrate. The surface of the insulating layer facing away from the address electrodes and the second surface of the first substrate may be aligned to define a substantially flat surface. The sustain electrodes may be on the substantially flat surface. The PDP may further include a dielectric layer on the sustain electrodes and a protection layer covering at least a portion of the dielectric layer.

The address electrodes may include a transparent material. The address electrodes may overlap non-discharge regions of the discharge cells. The address electrodes may overlap the barrier ribs. The sustain electrodes may include electrode pairs having a first sustain electrode and a second sustain electrode, each of the first sustain electrodes having a bus electrode extending along the second direction and a transparent electrode protruding toward the second sustain electrode, and each of the second sustain electrodes includes a bus electrode extending along the second direction and a transparent electrode protruding toward the first sustain electrode. The bus electrodes of the first and second sustain electrodes may overlap non-discharge regions of the discharge cells. The bus electrodes of the first and second sustain electrodes may overlap the barrier ribs. Light generated in the discharge cells may be transmitted toward the second substrate. The address electrodes and the sustain electrodes may include a reflective material.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded, perspective view of a PDP according to an embodiment of the present invention;

FIG. 2 illustrates a cross-sectional view along line II-II of the PDP of FIG. 1;

FIG. 3 illustrates a cross-sectional view along line III-III of the PDP of FIG. 1;

FIG. 4 illustrates an exploded, perspective view of a PDP according to another embodiment of the present invention;

FIG. 5 illustrates a cross-sectional view along line V-V of the PDP of FIG. 4;

FIG. 6 illustrates an exploded, perspective view of a PDP according to another embodiment of the present invention; and

FIG. 7 illustrates a cross-sectional view of a PDP according to another embodiment of the present invention.

### DETAILED DESCRIPTION OF THE INVENTION

Korean Patent Application No. 10-2007-0053411, filed on May 31, 2007, in the Korean Intellectual Property Office, and entitled: “Plasma Display Panel,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when an element is referred to as being “on” another element or substrate, it can be directly on the other element or substrate, or intervening elements may also be present. Further, it will be understood that the term “on” can indicate solely a vertical arrangement of one element with respect to another element, and may not indicate a vertical orientation, e.g., a horizontal orientation. In addition, it will also be understood that when an element is referred to as being “between” two elements, it can be the only element between the two elements, or one or more intervening elements may also be present. Like reference numerals refer to like elements throughout.

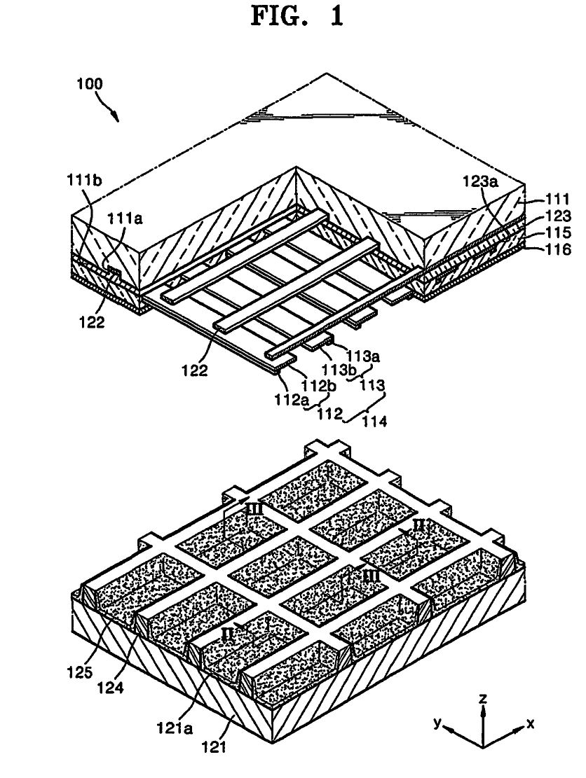

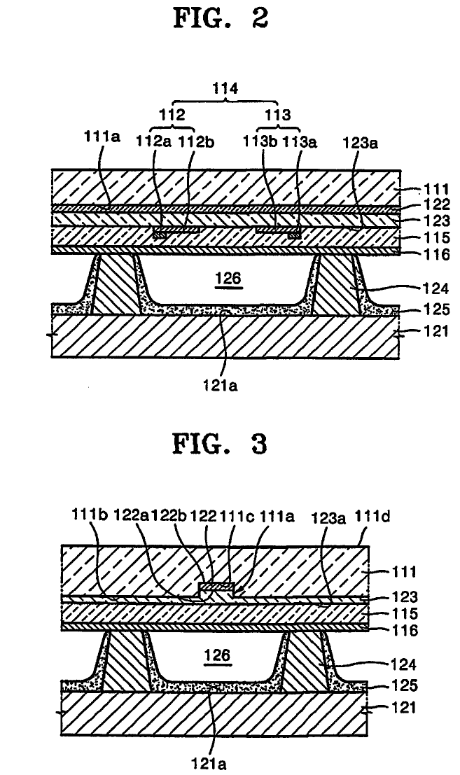

FIG. 1 illustrates an exploded, perspective view of a PDP 100 according to an embodiment of the present invention. FIG. 2 illustrates a cross-sectional view along line II-II of the PDP 100 of FIG. 1. FIG. 3 illustrates a cross-sectional view along line III-III of the PDP 100 of FIG. 1.

Referring to FIGS. 1-3, a first substrate 111 and a second substrate 121 may be spaced apart, and may be disposed to face each other. Each of the first and second substrates 111 and 121 may be formed of a transparent material, e.g., glass, an opaque material, e.g., plastic or metal, or a combination thereof. The first substrate 111 may include a first surface 111d, i.e., a surface facing away from the second substrate 121, and a second surface 111b, i.e., a surface opposite the first surface 111d. The second surface 111b of the first substrate 111 may be between the second substrate 121 and the first surface 111d of the first substrate 111. A plurality of grooves 111a may be formed along a first direction, e.g., along the x-axis, in the second surface 111b of the first substrate 111.

More specifically, the grooves 111a may extend along a length of the first substrate 111, i.e., along the x-axis. The grooves 111a may have a predetermined depth, i.e., a distance measured from the second surface 111b of the first substrate 111 along the z-axis toward the first surface 111d of the first substrate 111. The depth of the grooves 111a may be smaller than a thickness of the first substrate 111, i.e., a distance between the first and second surfaces 111b and 111d of the first substrate 111 along the z-axis. The grooves 111a may be spaced apart from each other along the y-axis, e.g., the grooves 111a may have a stripe pattern, and may have, e.g., a tetragonal cross section in the yz-plane with a predetermined width along the y-axis. For example, each groove 111a may include a bottom surface 111c parallel to the second surface 111b of the first substrate 111, as illustrated in FIG. 3, and vertical surfaces.

A plurality of address electrodes 122 may be formed in the grooves 111a. More specifically, the address electrodes 122 may be formed on the bottom surfaces 111c of the grooves 111a to extend along the first direction, e.g., along the x-axis. Each address electrode 122 may be formed in a corresponding groove 111a, so a first surface 122b of the address electrode 122 may be on the bottom surface 111c of the grooves 111a and a second surface 122a of the address electrode 122, i.e., a surface opposite the first surface 122b, may face the second substrate 121. A thickness of the address electrodes 122, i.e., a distance between the first and second surfaces of the address electrode 122 along the z-axis, may be smaller than the depth of the grooves 111a. Accordingly, when the address electrodes 122 are formed, e.g., directly, on the bottom surfaces 111c of the grooves 111a, spaces may be formed between the address electrodes 122 and the second surface 111b of the first substrate 111. More specifically, as illustrated in FIGS. 1 and 3, the second surfaces 122a of the address electrodes 122, i.e., surfaces of the address electrode 122 facing the second substrate 121, may be inside the grooves 111a. Accordingly, a predetermined vertical distance, i.e., a distance as measured along the z-axis, may be formed between the second surfaces 122a of the address electrodes 122 and the second surfaces 111b of the first substrate 111.

The address electrodes 122 may be formed of a conductive material, e.g., metal. For example, if light generated inside the PDP 100 is emitted toward the first substrate 111, i.e., through the address electrodes 122, the address electrodes 122 may be formed of a transparent conductive material, e.g., indium tin oxide (ITO). In another example, if light generated inside the PDP 100 is emitted toward the second substrate 121, i.e., away from the address electrodes 122, the address electrodes 122 may be formed of a reflective conductive material, e.g., aluminum, in order to improve brightness outside the PDP 100 by increasing the light extraction efficiency of the PDP 100.

An insulating layer 123 may be formed on the first substrate 111 to face the second substrate 121. The insulating layer 123 may be formed on the second surface 111b of the first substrate 111 and on the second surfaces 122a of the address electrodes 122. In other words, portions of the insulating layer 123 may be deposited in the grooves 111a to cover the address electrodes 122. For example, portions of the insulating layer 123 may completely fill the spaces in the grooves 111a between the address electrodes 122 and the second surface 111b of the first substrate 111, so a surface 123a of the insulating layer 123, i.e., a surface facing the second substrate 121, may be substantially flat. The insulating layer 123 may be formed of any suitable material, e.g., silicon oxide, silicon nitride, and so forth. If light generated in the PDP 100 is emitted toward the first substrate 111, the insulating layer 123 may be formed of a transparent material. If light generated in the PDP 100 is emitted toward the second substrate 121, the address electrodes 122 may be formed of a reflective material, e.g., a white-colored insulating material having high reflection characteristics.

A plurality of sustain electrode pairs 114 may be formed on the surface 123a of the insulating layer 123. The sustain electrode pairs 114 may extend along a second direction, e.g., along the y-axis, to cross the address electrodes 122. Each sustain electrode pair 114 may include a first sustain electrode 112 and a second sustain electrode 113 spaced apart from each other. The first sustain electrode 112 and the second sustain electrode 113 may generate sustain discharge therebetween to realize an image of the PDP 100.

The first sustain electrode 112 and the second sustain electrode 113 may be formed of a conductive metal, e.g., aluminum or copper. If light generated in the PDP 100 is transmitted toward the first substrate 111, i.e., through the sustain electrode pairs 114, the sustain electrode pairs 114 may be formed to be transparent, e.g., formed of ITO. If light generated in the PDP 100 is transmitted toward the second substrate 121, i.e., away from the sustain electrode pairs 114, the sustain electrode pairs 114 may be formed of a reflective material to improve the brightness outside the PDP 100 by increasing the light extraction efficiency of the PDP 100. If the first and second sustain electrodes 112 and 113 include transparent material, each of the first and second sustain electrodes 112 and 113 may include a bus electrode and a transparent electrode.

As illustrated in FIGS. 1-2, the first sustain electrodes 112 may include bus electrodes 112a extending along the second direction, e.g., along the y-axis, and transparent electrode 112b electrically connected to the bus electrodes 112a and protruding toward respective second sustain electrodes 113. The second sustain electrodes 113 may include bus electrodes 113a extending along the second direction, e.g., along the y-axis, and transparent electrodes 113b electrically connected to the bus electrodes 113a and protruding toward respective first sustain electrodes 112. The transparent electrodes 112b and 113b may extend along the second direction, and may be electrically connected to the bus electrodes 112a and 113a, respectively. The transparent electrodes 112b and 113b may correspond to discharge cells 126. The bus electrodes 112a and 113a may reduce resistance of the transparent electrodes 112b and 113b, respectively, so a decrease in voltage along the second direction, e.g., y-axis, may be prevented or substantially minimized.

The bus electrodes 112a and 113a may be formed of a material having low resistance and high electrical conductivity, e.g., one or more of silver, copper, gold, and/or aluminum. Also, the bus electrodes 112a and 113a may include a black additive or may be formed to have a multi-layer structure including a layer formed of a dark material in order to improve contrast of the PDP 100. Since the first and second sustain electrodes 112 and 113 are connected to a connection cable (not shown) on a peripheral portion of the PDP 100 to receive power supply, various arrangements of the first and second sustain electrodes 112 and 113, e.g., only the bus electrodes 112a and 113a may be connected to the connection cable, are within the scope of the present invention. If light is transmitted toward the first substrate 111, the bus electrodes 112a and 113a of the first and second sustain electrodes 112 and 113 may be formed in non-discharge regions of the PDP 100, e.g., peripheral portions of discharge cells 126.

A first dielectric layer 115 may be formed on the insulation layer 123 to cover the sustain electrode pairs 114. The first dielectric layer 115 may prevent direct contact between the first sustain electrodes 112 and the second sustain electrodes 113, and may prevent or substantially minimize damage to the first and second sustain electrodes 112 and 113 due to collision of charged particles therewith. The first dielectric layer 115 may include any suitable dielectric material, e.g., one or more of PbO, B₂O₃, and/or SiO₂. If light generated inside the PDP 100 is transmitted toward the first substrate 111, the first dielectric layer 115 may be formed of a transparent material, and may be coated with a protection layer 116. For example, as illustrated in FIG. 1, an entire surface of the first dielectric layer 115 may be covered by the protection layer 116, e.g., a layer formed by depositing MgO on the first dielectric layer 115, to minimize contact with charged particles. The protection layer 116 may also activate discharge by emitting second electrons.

Barrier ribs 124 may be formed between the first and second substrates 111 and 121 to define discharge cells 126 between the first and second substrates 111 and 121. For example, as illustrated in FIGS. 1-3, the barrier ribs 124 may be formed on the second substrate 121, and may extend vertically along the z-axis toward the first substrate 111. The barrier ribs 124 may be formed in any suitable pattern, e.g., a lattice pattern, a stripe pattern, and so forth, and may define non-discharge regions of the discharge cells 126. For example, the bus electrodes 112a and 113a of the first and second sustain electrodes 112 and 113 may be formed to overlap the barrier ribs 124, so light emission from the discharge cells 126 may be optimized.

The discharge cells 126 may have any suitable cross-section, e.g., a triangle, a tetragon, a pentagon, a circle, an oval, and/or any other suitable geometric structure. For example, as illustrated in FIG. 1, the barrier ribs 124 may include portions arranged in a stripe pattern along the y-axis and portions arranged in a stripe pattern along the x-axis to define the discharge cells 126 in a matrix pattern with tetragonal cross-sections. In another example, if the discharge cells 126 are arranged in a matrix pattern, as illustrated in FIG. 1, each groove 111a with a respective address electrode 122 therein may extend along and correspond to one array of discharge cells 126 along the x-axis. Other configurations of the barrier ribs 124, e.g., the barrier ribs 124 may be formed on the first substrate 111 to extend toward the second substrate 121, the barrier ribs 124 may be configured to define the discharge cells 126 to have a delta structure, and so forth, are within the scope of the present invention. Peripheral portions of the discharge cells 126 may be referred to as non-discharge region of the PDP 100, and may include, e.g., the barrier ribs 124.

A phosphor layer 125 may be formed inside each of the discharge cells 126, as illustrated in FIG. 2. For example, the phosphor layer may be formed on the second substrate 121 and on sidewalls of the barrier ribs 124. The phosphor layer 125 may include a red light emitting phosphor, a green light emitting phosphor, and/or a blue light emitting phosphor. The red light emitting phosphor may be, e.g., Y(V,P)O₄:Eu. The green light emitting phosphor may be, e.g., Zn₂Si O₄:Mn, YBO₃:Tb, and so forth. The blue light emitting phosphor may be, e.g., BAM:Eu. The phosphor layer 125 may be formed by mixing at least one phosphor with a solvent and a binder to form a phosphor paste, applying the phosphor paste to predetermined portions of the discharge cells 126, e.g., on a surface 121a of the second substrate 121 and/or on the sidewall of the barrier ribs 124, and drying and plasticizing the phosphor paste.

A discharge gas, e.g., neon (Ne), xenon (Xe), helium (He), and so forth, may be injected inside the discharge cells 126. For example, the discharge gas may include a mixture containing Xe gas in an amount of about 5% to about 15% of a total volume of the discharge gas and Ne gas. At least a portion of the Ne gas may be substituted with He gas according to necessity. Also, other gases may be used as the discharge gas, or the inside of the discharge cells 126 may include vacuum.

The PDP 100 illustrated in FIGS. 1-3 may be driven as follows. Voltage may be applied to the address electrodes 122 and to at least one of the first sustain electrodes 112 and the second sustain electrodes 113 to generate address discharge therebetween to select discharge cells 126 to be operated. Next, voltage may be applied to pairs of first and second sustain electrodes 112 and 113 of selected discharge cells 126 to generate sustain discharge therebetween. The structure of the electrodes, i.e., sustain electrode pairs 114 along the second direction and address electrodes 122 along the first direction crossing the second direction, may provide intersection points of the electrodes to correspond to respective discharge cells 126.

A PDP according to embodiments of the present invention may be advantageous in providing address electrodes 122 and sustain electrodes 114 with small distances therebetween. The reduced distances between the electrodes may facilitate driving the PDP 100 at a low voltage and with high efficiency.

More specifically, the conventional PDP may include sustain electrodes and address electrodes on different substrates having barrier ribs therebetween, thereby forming a relatively large distance between the sustain and address electrodes. The relatively large distance between the sustain and address electrodes may generate a relatively high potential difference therebetween, which in turn may generate discharge at a relatively high voltage and may reduce life time of the address and sustain electrodes. The PDP 100 according to embodiments of the present invention, however, may minimize distance between the address electrodes 122 and the sustain electrodes pairs 114 by forming both the address electrodes 122 and the sustain electrodes pairs 114 on the first substrate 111. Accordingly, address discharge of the PDP 100 may be generated via a reduced potential difference between the address electrodes 122 and at least one of the first sustain electrodes 112 and the second sustain electrodes 113. As the PDP 100 may be driven at a low voltage, the life time of the electrodes of the PDP 100 may be extended, so overall life time of the PDP 100 may be increased.

In particular, a PDP according to embodiments of the present invention may be advantageous in providing grooves in a first substrate, so address electrodes may be formed inside the grooves, followed by formation of sustain electrodes on the first substrate. Formation of the address electrodes inside the grooves may be advantageous in providing a substantially flat surface for forming sustain electrodes thereon.

For example, formation of address electrodes directly on a surface of the first substrate, i.e., not in grooves, may form a substrate with an uneven surface, e.g., form curves on the substrate due to the address electrodes protruding from a surface thereof. An uneven surface, i.e., a non-flat surface, of the substrate may cause flawed electrical connections, e.g., disconnected sustain electrodes, and insufficient isolation between adjacent discharge cells, e.g., discharge cells may not be completely isolated from each other, thereby deteriorating image clarity of the PDP. Therefore, the PDP 100 according to embodiments of the present invention may be advantageous in providing address electrodes in grooves, so sustain electrodes may be formed on a substantially flat surface on a same substrate as the address electrodes to prevent problems described above.

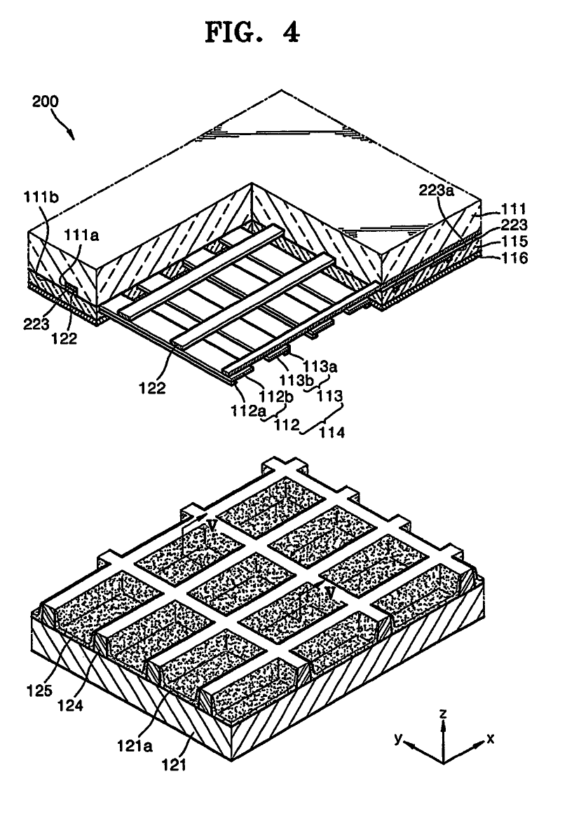

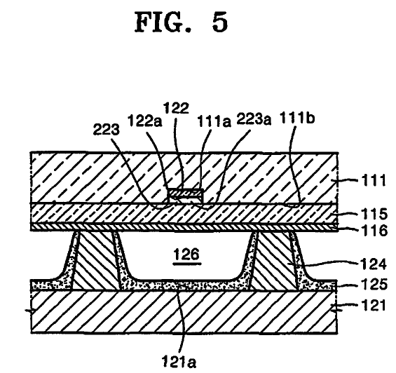

FIG. 4 illustrates an exploded perspective view of a PDP according to another embodiment of the present invention. FIG. 5 illustrates a cross-sectional view along line V-V of the PDP of FIG. 4. Referring to FIGS. 4-5, a PDP 200 may be substantially similar to the PDP 100 described previously with reference to FIGS. 1-3, with the exception of the PDP 200 including an insulation layer 223 instead of the insulation layer 123.

In particular, the insulating layer 223 of the PDP 200 may be formed only inside the grooves 111 a. More specifically, the insulating layer 123 of the DPP 100 may be formed over the entire second surface 111b of the first substrate 111, and may include portions completely filling the grooves 111a. The insulation layer 223 of the PDP 200, on the other hand, may include only portions to fill the grooves 111a. The insulation layer 223 may include discrete portions, so each portion of the discrete portions may be disposed on a second surface 122a of a corresponding address electrode 122, as illustrated in FIGS. 4-5. The portions of the insulation layer 223 may completely fill the spaces between the second surfaces 122a of the address electrodes 122 and the second surface 111b of the first substrate 111. Accordingly, a surface 223a of each portion of the insulating layer 223, i.e., a surface facing the second substrate 121, may substantially align with the second surface 11 b of the first substrate 111 along the xy-plane. In other words, the surface 223a of the insulating layer 223 may be substantially level with the second surface 111b of the first substrate 111 to form a substantially flat surface.

Accordingly, the sustain electrode pairs 114 may be formed on a flat surface, i.e., on a surface formed by the insulating layer 223 and the second surface 111b of the first substrate 111. For example, first portions of the sustain electrode pairs 114 may be in direct contact with the first substrate 111, and second portions of the sustain electrode pairs 114 may be in direct contact with the insulating layer 223. The first dielectric layer 115 may be formed on the first substrate 111 to cover the sustain electrode pairs 114.

Formation of the insulating layer 223 may include advantages described previously with reference to the PDP 100 of FIGS. 1-3. In addition, formation of the insulating layer 223 only in predetermined portions of the first substrate 111, i.e., overlapping with the address electrodes 122, may be advantageous in reducing a number of layers and/or elements in emission regions of the discharge cells 126, i.e., regions between the discharge cells 126 and the first substrate 111 other than areas entirely overlapping the address electrodes 122. Accordingly, light transmittance through the PDP 200 may be enhanced when light is emitted toward the first substrate 111, so brightness and light efficiency may be increased.

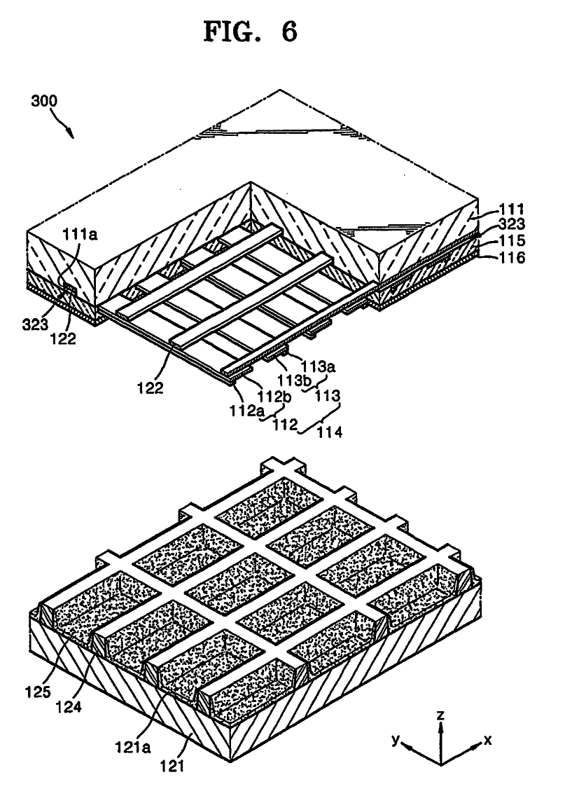

FIG. 6 illustrates an exploded, perspective view of a PDP according to another embodiment of the present invention. Referring to FIG. 6, a PDP 300 may be substantially similar to the PDP 200 described previously with reference to FIGS. 4-5, with the exception of the PDP 300 including a space 323 instead of the insulation layer 223. In particular, the space 323 of the PDP 300 may be formed between the second surfaces 122a of the address electrodes 122 and the second surface 111b of the first substrate 111, so the space 323, i.e., air, may function as an insulator. Accordingly, the sustain electrode pairs 114 may be formed on the second surface 111b of the first substrate 111, and the spaces 323 may be between overlapping portions of the address electrodes 122 from the sustain electrode pairs 114. The sustain electrode pairs 114 of the PDP 300 may be formed in a form of a film on the second surface 111b of the first substrate 111 using a laminating method or a thermal transfer method.

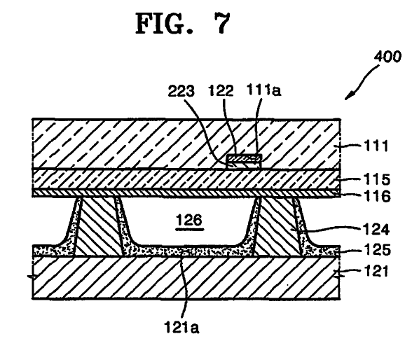

FIG. 7 illustrates a cross-sectional view of a PDP according to another embodiment of the present invention. A PDP 400 may be substantially similar to the PDP 100, PDP 200, and/or PDP 300 described previously with reference to FIGS. 1-6, with the exception of forming the address electrodes 122 to correspond to the non-discharge regions of the discharge cells 126. For example, as illustrated in FIG. 7, the groves 111a and the address electrodes 122 therein may be formed to correspond to a peripheral portion of the discharge cells 126. In another example, the address electrodes 122 may overlap at least a portion of the barrier ribs 214.

A PDP according to embodiments of the present invention may be driven at a low voltage and may have improved light emitting efficiency, discharge stability, and high discharge efficiency.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate having first and second surfaces opposite each other, the first substrate including a plurality of grooves in the second surface, the grooves extending along a first direction;
a plurality of address electrodes in the grooves along the first direction, a thickness of the address electrodes being smaller than a depth of the grooves to define a space between each address electrode and the second surface of the first substrate;
a plurality of sustain electrodes on the second surface of the first substrate along a second direction, the second direction crossing the first direction;
a second substrate facing the second surface of the first substrate;
barrier ribs between the first and second substrates to define discharge cells between the first and second substrates; and
at least one phosphor layer in each of the discharge cells.

2. The PDP as claimed in claim 1, further comprising an insulating layer between the address electrodes and the sustain electrodes.

3. The PDP as claimed in claim 2, wherein the insulating layer is inside the grooves on the address electrodes.

4. The PDP as claimed in claim 3, wherein the insulating layer is on the address electrodes and on the second surface of the first substrate.

5. The PDP as claimed in claim 4, wherein a surface of the insulating layer facing away from the address electrodes is substantially flat.

6. The PDP as claimed in claim 3, wherein the insulating layer is only inside the grooves.

7. The PDP as claimed in claim 6, wherein the insulating layer includes a plurality of discrete portions, each portion being in a respective groove.

8. The PDP as claimed in claim 6, wherein the insulating layer completely fills the spaces between the address electrode and the second surface of the first substrate.

9. The PDP as claimed in claim 8, wherein a surface of the insulating layer facing away from the address electrodes is substantially level with the second surface of the first substrate.

10. The PDP as claimed in claim 8, wherein the surface of the insulating layer facing away from the address electrodes and the second surface of the first surface are aligned to define a substantially flat substrate.

11. The PDP as claimed in claim 10, wherein the sustain electrodes are on the substantially flat surface.

12. The PDP as claimed in claim 11, further comprising a dielectric layer on the sustain electrodes and a protection layer covering at least a portion of the dielectric layer.

13. The PDP as claimed in claim 1, wherein the address electrodes include a transparent material.

14. The PDP as claimed in claim 1, wherein the address electrodes overlap non-discharge regions of the discharge cells.

15. The PDP as claimed in claim 14, wherein the address electrodes overlap the barrier ribs.

16. The PDP as claimed in claim 1, wherein the sustain electrodes include electrode pairs having a first sustain electrode and a second sustain electrode, each of the first sustain electrodes having a bus electrode extending along the second direction and a transparent electrode protruding toward the second sustain electrode, and each of the second sustain electrodes includes a bus electrode extending along the second direction and a transparent electrode protruding toward the first sustain electrode.

17. The PDP as claimed in claim 16, wherein the bus electrodes of the first and second sustain electrodes overlap non-discharge regions of the discharge cells.

18. The PDP as claimed in claim 17, wherein the bus electrodes of the first and second sustain electrodes overlap the barrier ribs.

19. The PDP as claimed in claim 1, wherein light generated in the discharge cells is transmitted toward the second substrate.

20. The PDP as claimed in claim 19, wherein the address electrodes and the sustain electrodes include a reflective material.
